(19) United States
(12) Patent Application Publication
(10) Pub. No.: US 2016/0281356 A1
(43) Pub. Date: Sep. 29, 2016

(54) MACHINE FOR MAKING INTERLOCKING AND INTERFITTING MASONRY UNITS AND MASONRY SYSTEM THEREOF

(71) Applicant: Sachchida Nand Sinha, New Delhi (IN)

(72) Inventor: Sachchida Nand Sinha, New Delhi (IN)

(21) Appl. No.: 15/037,188

(22) PCT Filed: Oct. 30, 2014
(86) PCT No.: PCT/IN2014/000688

§ 371 Date: May 17, 2016

(30) Foreign Application Priority Data
Nov. 29, 2013 (IN) 3485/DEL/2013

(51) Int. Cl. E04C 1/39; E04B 2/40; E04B 2/32; B28B 7/18; B28B 3/08

(52) U.S. Cl. CPC E04C 1/39; B28B 7/183; B28B 3/08; E04B 2/32; E04B 2/40; E04B 2002/0208

(57) ABSTRACT

The present invention relates to a machine for making solid as well hollow interlocking and interfitting masonry units and masonry system for semi-automated masonry construction. Self-alignment and self-adjustment of the masonry units is achieved due to its interlocking and interfitting features resulting in a gap all around two masonry units within their width which are interconnected throughout the masonry work enabling bonding of masonry units by pumping cement and water slurry from one or more points. The present invention also relates to masonry unit for making formwork for columns and shear walls and also to masonry units for L, T and + joints in masonry work produced by modifying moulds in above referenced machines. The present invention also relates to machine to manufacture masonry units of any dimensions depending on its requirement out of a suitable combination of materials such as cement, lime, gypsum, fly ash, sand, dust of stone etc.

### FIELD OF INVENTION

The present invention relates to a machine for making solid as well hollow interlocking and interfitting masonry units and masonry system for semi-automated masonry construction. Self-alignment and self-adjustment of the masonry units is achieved due to its interlocking and interfitting features resulting in a gap all around two masonry units within their width which are interconnected through out the masonry work enabling bonding of the masonry units by pumping cement and water slurry from one or more points.

The present invention also relates to a machine to make masonry units that are dry staked, mortar less masonry due to its interlocking and interfitting features that restrain its displacement in all three directions, thus eliminating the need of bonding of such masonry units with mortar. The strength of masonry wall is about two times the strength of masonry wall made with conventional masonry units of same strength of masonry unit.

The present invention also relates to a masonry unit for making formwork for columns and shear walls to replace wooden or steel formwork.

The present invention also relates to masonry units for L, T and + joints in masonry work produced by modifying moulds in above referenced machines.

The present invention also relates to reinforced masonry that can be made by modifying moulds to achieve the provision for providing reinforcement in the masonry work.

The present invention also relates to machine to manufacture masonry units of any dimensions depending on its requirement out of a suitable combination of materials such as cement, lime, gypsum, fly ash, sand, dust of stone/marble/granite, clay etc.

The masonry construction is faster, more economical and more efficient as the self-alignment and self adjustment properties of the masonry unit results in a superior and uniform quality of construction leading to reduced manpower requirement and reduced time of construction. Hollow masonry units result in increased thermal insulation and reduced weight hence reduced earthquake forces resulting in reduced cost. Dry staked, mortar less masonry eliminate the need of bonding of masonry units with mortar.

### BACKGROUND OF INVENTION

Automation has been introduced to a very limited extent in the field of masonry construction in comparison to other classes of structures.

The conventional masonry construction is the assembly of masonry units such as bricks, blocks and stone by laying such units horizontally and vertically adjacent to each other into a wall, column or other structures. These building units (bricks, blocks and stone) are joined by mortar; the mortar sets up, cementing the masonry units together as it hardens. Such masonry construction has distinctive architectural characteristics, which has been desired since ages, and is still the preferred type of construction.

One of the problems associated with the existing masonry construction is non-uniformity in masonry construction and masonry units. Mortar is typically mixed at the site of construction work and could potentially be used beyond its useful mix life.

Another problem is that the thickness of mortar may vary considerably which results in large variation in quality of work. This in turn leads to variation in strength of masonry walls. At times the masonry units and walls are not properly aligned due to which the masonry walls require a larger thickness of mortar and or plaster.

A concrete building block was developed in UK (GB19930007892, 1993) which has U-shaped channels and projections for interlocking with other similar blocks. The block may be made in a shaped mould subdivided by members having U-shaped portions flanked by flat portions to mould channels and projections.

Another masonry unit was developed by a construction company in New York for building insulated walls for energy conservation. The masonry block comprises of two masonry shells with inner faces that interlock with a Styrofoam layer inserted between them for thermal insulation. The resulting configuration of the block facilitates self-spacing and allows laying a number of courses of blocks without applying mortar on the bed joints, which can be subsequently injected into the gaps formed between adjacent courses.

Dry stacked interlocking mortar less and surface bonded masonry have been developed and used in various countries. A consolidated review of such masonry units is given in Table-1. Such masonry blocks can be classified as per the interlocking mechanism as Tongue and groove arrangement, Dovetail arrangement,

Projecting nibs, Synthetic strips, Grouted systems, Interlocking blocks of highly complex shape etc. as shown in FIG. 1.

Automation in masonry construction is mostly restricted to the prefabrication industry. The concept and technique of prefabricating brick masonry sections was developed in France, Switzerland and Denmark in the 1950s and adopted in the United States in the early 1960s. Prefabricated masonry is presently manufactured manually for preassembling masonry sections and by casting method with the use of automated system.

TABLE 1
Consolidated review of masonry units

| | Haener [symbol] | Mecano [symbol] | Sparlock [symbol] | WHD [symbol] | TASTA [symbol] | Linkbloc [symbol] |
|---|---|---|---|---|---|---|
| Name [symbol] f | block [symbol] | System [symbol] | System [symbol] | System [symbol] | System [symbol] | system [symbol] |
| System | (1975) | (1987) | (1986) | (1992) | (1988) | (1990) |
| Country | U.S.A | Peru | Canada | U.S.A | Netherlands | South [symbol] |
| | | | | | | Africa |
| Block [symbol] ype | Hollow | Hollow | Hollow | Hollow | Solid | Hollow |
| Interlocking [symbol] hrough [symbol] | ✓ | x | ✓ | ✓ | x | ✓ |
| block [symbol] onfiguration | | | | | | |
| Bed [symbol] oint [symbol] nterlocking | ✓ | x | x | x | x | ✓ |
| | Projecting [symbol] | | | | | Projection [symbol] |
| | nibs | | | | | & [symbol] ecess |
| Head [symbol] oint [symbol] nterlocking | ✓ | x | x | ✓ | x | x |
| | Tongue [symbol] | | | Dovetail [symbol] | | |
| | groove | | | lug | | |
| Bonding [symbol] aterial [symbol] | x | ✓ | x | x | ✓ | x |
| requirement [symbol] or [symbol] tability | | Requires [symbol] | | | Synthetic [symbol] | |
| | | grouting [symbol] | | | strips [symbol] sed | |
| | | for [symbol] | | | | |
| | | stability | | | | |
| Dry [symbol] tacked [symbol] asonry | x | x | ✓ Upto [symbol] | x | x | ✓ |
| | | | 2.8m [symbol] igh | | | |
| Surface [symbol] onded [symbol] | ✓ | x | ✓ | x | ✓ | x |
| masonry | | | | | Surface [symbol] | |
| | | | | | bonding [symbol] | |
| | | | | | required | |
| Grouted | ✓ | ✓ | ✓ | ✓ | ✓ | ✓ |
| Masonry | | Gouting [symbol] | | | | |
| | | madatory | | | | |

### PRIOR ART

U.S. Pat. No. 4,262,463 (1981) describes pressed blocks for interlocked assembly.

It comprises of male assembly means projecting from the first face and female assembly on the second face of the block for interlocking.

U.S. Pat. No. 4,896,472 (1990) is based on the combined use of blocks designed to lock together. There are three basic blocks—the full, half and the knock-out blocks, with which any desired structure can be built. It provides for a wide array of interlocking positions.

U.S. Pat. No. 5,802,797 (1995) describes a masonry system in which specially shaped bricks are dry stacked and subsequently bonded by pouring mortar or grout into apertures in the brick to flow through the stacked structure. The brick have alignment projection from the bottom bed faces, which register with alignment groove in the top bed face of the lower brick to align the upper brick prior to bonding.

U.S. Pat. No. 6,065,265 (2000) describes an interlocking building block for use in constructing mortar less walls in which the block has a first face shell in spaced relationship with a second face shell which define inner surface for the block.

In U.S. Pat. No. 6,244,009 (2001), a masonry wall system is disclosed incorporating a plurality of courses of masonry blocks, each block consisting of interlocking dovetail along with vertical and horizontal melting surfaces.

### OBJECTIVE OF INVENTION

The objective of the present invention is to make a machine to manufacture both solid and hollow interlocking and interfitting masonry units of any dimension depending on its requirement out of suitable combination of materials such as cement, lime, gypsum, fly ash, sand, dust of stone/marble/granite, clay etc. and masonry system for semi-automated masonry construction.

Another objective of the present invention is a machine to manufacture building units faster and cheaper than the conventional masonry units.

Another objective of the present invention is to make a machine to achieve self-alignment and self-adjustment of the masonry units due to its interlocking and interfitting features.

Another objective of the invention is to achieve better quality of work due to self-alignment and self-adjustment of masonry units and formation of gap within the width of masonry units all around masonry units and inter connected in the masonry system when one masonry unit is interlocked and interfitted with the adjacent masonry unit so that uniform bonding is achieved by pumping slurry from the top or from the sides as appropriate. This reduces time of construction and manpower requirements as even an unskilled worker can do construction.

Another objective of invention is to make a machine to make masonry units to achieve dry staked, mortar less masonry due to interlocking and interfitting features of masonry unit that restrain its displacement in all three directions, thus eliminating the need of bonding of masonry units with mortar.

The manufacture of the masonry units is such that the thickness of slurry for bonding of masonry units shall be small under automated masonry construction. Therefore the strength of the proposed masonry shall be large as compared to the strength of the conventional masonry. The strength of such masonry wall is as high as 70 to 80 percent of the strength of masonry unit where as the strength of conventional masonry wall is only 30 to 40 percent of the strength of masonry unit.

Another objective of invention is to make a machine to provide a large void in the hollow masonry unit to reduce the dead weight of wall resulting in reduced weight of building that will result in reduced earthquake load thus making the building more economical. This will also provide thermal insulation, thus reducing the cost of cooling and heating.

Plaster is not required on any of the vertical faces of the wall constructed with the invented masonry units, as both the vertical faces are plane and smooth.

Curing of wall is not required, as the slurry for bonding the masonry units shall be confined within the thickness of wall.

Another objective of invention is to make a channel shaped masonry unit for formwork of columns and shear walls, which shall be an integral part of column or shear wall. Thus the cost and time of construction shall reduce.

Another objective of invention of machine is to make masonry units for construction of masonry system at L, T and + joints by modifying the moulds.

Another objective of invention of machine is to make masonry units for construction of reinforced masonry by modifying the moulds.

### DESCRIPTION

The present invention relates to a machine for making solid and hollow masonry units with interlocking and interfitting projections and depressions, which are self-aligned and self-adjustable. Both solid and hollow masonry units of any dimensions such as 300 mm length, 200 mm width and 150 mm depth or 300 mm length, 100 mm width and 150 mm depth or 300 mm length, 75 mm width and 150 mm depth can be manufactured. The length, width and depth of masonry units can be varied depending on the requirement.

According to another embodiment of the invention, the masonry unit is made of any material such as clay in plastic stage which requires to be burnt or a homogeneous mixture of about 5 to 20 percent of cement, 30 to70 percent of fly ash, 20 to 60 percent of sand or a homogeneous mixture of 5 to 20 percent of cement, 30 to 70 percent of fly ash, 20 to 60 percent of clay or a homogeneous mixture of 5 to 20 percent of cement, 30 to 70 percent of sand, 20 to 60 percent of clay. The mixture may also consist of suitable proportion of other bonding material such as lime and gypsum. Sand may be river sand or stone or marble or granite dust in suitable proportion. All ingredients of materials for making masonry units are mixed with an appropriate quantity of water to make a moist mix. Water may be mixed with an appropriate quantity of plasticizer of desired property. A suitable quantity of fibre may also be used.

According to another embodiment of the invention, a machine (FIGS. 2 and 3) for making units comprising of a brick making unit (10), a brick ejection unit (11) and a hydraulic system (13) is described having:
Moulds (100) provided in the brick making unit comprising of bottom, top and endplates with interlocking and interfitting features and plane vertical plates,
An ejection unit (11) provided adjacent to the brick making unit (10) to receive masonry units after ejection from the mould having plate longitudinally larger than the length of the masonry unit,
A plurality of hydraulic jacks (15, 16) provided for movements of end plates of the moulds from both ends to make masonry units at a pressure of about 40 to 60 kg persq.cm and another jack (14) provided to move shafts (20) along the length of mould to make hollow in the masonry units.

These are described as follows:

Brick making unit: It is the main unit where moulds for making masonry units are mounted. Seven types of moulds have been developed to make seven types of masonry units. The bottom and top plates of moulds have interlocking and interfitting features. The bottom plate is mounted at the top plates of brick making table with bolts. The vertical plates are plane and mounted on bottom plates with bolts. The top horizontal plate is shorter than the bottom horizontal plate to make provision for hopper for filling material in the moulds. It is mounted with vertical plates. The end plates are connected with jacks for their movement in the moulds. The inside configuration of moulds conform to masonry unit. Seven different types of moulds are described as follows:

According to another embodiment of the invention, Mould-1 (FIG. 4) is for making solid rectangular masonry unit-1 as shown in FIG. 11. The plan of brick making unit has been shown in FIG. 4A where moulds for making masonry units are installed. FIG. 4B shows the elevation and section of mould (100) for making masonry unit. Bottom horizontal plate-1 (101) of mould has a depression within its width and along its length and the top horizontal plate-2 (102) has matching projection within its width and along its length in conformity with the said depression as shown in the figure. One of the end plate-1 (301) of mould (100) has a depression within its width and along its height and the other end plate-2 (302) has a matching projection within its width and along its height in conformity with the said depression. The end plates are connected with jacks (15, 16) for movement inside and outside the mould. The vertical plates (201, 202) are plane.

According to another embodiment of the invention, Mould-2 (FIG. 5) is for making hollow rectangular masonry unit as shown in FIG. 12 with an opening from one end and closed on other end. It is hollow along the length of masonry unit from one end. It is similar to mould-1 shown in FIG. 4 except that one of the end plates has an opening. A shaft (20) passes through the opening along the length of mould to make masonry unit hollow. Its horizontal plates (101, 102) are similar to that of mould-1 (FIG. 4). Its end plate without an opening and having interlocking and inter-fitting projection shall have other end plate with an opening having interlocking and inter-fitting depression within its four walls. Other mould with end plate without an opening shall have interlocking and inter-fitting depression and end plate with an opening shall have interlocking and inter-fitting projection within its four walls. The interlocking or interfitting projections and depressions within the four walls of end plate with an opening are similar to that of mould-1 fitting without any gap.

According to another embodiment of the invention, Mould-3 (FIG. 6) is for making solid masonry unit-3 as shown in FIG. 13. It is similar to mould-1 (FIG. 4) except that the middle half of the horizontal plates are projected outward by 5 to 20 mm depending on the size of the masonry unit. The upward projection of the middle half of horizontal plates is achieved by placing identical horizontal plates of thickness equal to the outward projection of the horizontal plates at its two ends as shown in FIG. 6B. It has identical interlocking and inter-fitting projections or depressions as that of the horizontal plates. It is fixed with the end plates such that its length within the mould is equal to one fourth of the length of masonry unit. The end plates are similar to that of mould-1.

According to another embodiment of the invention, Mould-4 (FIG. 7) is for making hollow masonry unit-4 as shown in FIG. 14 which is similar to mould-2 (FIG. 5) except that the middle half of the horizontal plates are projected outward by 5 mm to 20 mm depending on the size of the masonry unit similar to that of masonry unit-3.

According to another embodiment of the invention, Mould-5 (FIG. 8) is for making solid masonry unit to make dry staked, mortar less masonry due to interlocking and inter-fitting features of masonry units that restrain its displacement in all three directions, thus eliminating the bonding of masonry units with mortar. It is similar to that of mould-3 for solid masonry unit except that the interlocking and inter-fitting features in the end plates are within their height as shown in FIG. 8. The interlocking and inter-fitting features in horizontal and end plates are mirror images enabling interlocking and inter-fitting of masonry units without any gap. Thus the masonry units are restrained against displacement in all three directions.

According to another embodiment of the invention, Mould-6 (FIG. 9) is for making hollow masonry unit-6 to make dry staked, mortar less masonry due to interlocking and inter-fitting features that restrain its displacement in all three directions, thus eliminating the bonding of masonry units with mortar. It is similar to that of mould-4 for hollow masonry unit except that the interlocking and inter-fitting features in the end plate without an opening are within their height as shown in FIG. 9. The interlocking and inter-fitting features in horizontal and end plates are mirror images enabling interlocking and inter-fitting of masonry units without any gap. Thus the masonry units are restrained against displacement in all three directions.

According to another embodiment of the invention, Mould-7 (FIG. 10) is for making channel shaped masonry unit for shuttering of column and shear wall as shown in FIG. 15 which has interlocking and inter-fitting projections and depressions within their thickness on all exposed surfaces at the two ends and at the two longitudinal edges. Mould for making such masonry unit consists of a plane horizontal plate at bottom and plane vertical plates as shown in the figure. The top horizontal plate has interlocking and inter-fitting projection at one longitudinal edge and interlocking and inter-fitting depression at other longitudinal edge within the width equal to the thickness of masonry unit. Both the end plates are hollow of rectangular shape from top (FIG. 10) whose vertical and horizontal members are of width equal to the thickness of wall of masonry unit. A shaft passes through the opening of one of the end plates up to the other end plate touching the top horizontal plate. The vertical and bottom surfaces of shaft are rough so that the inner surfaces of mould are rough for proper bonding with the column. One of the end plate has interlocking and inter-fitting projection and the other end plate has interlocking and inter-fitting depression within the horizontal and vertical members (as shown in the figure) that are mirror images. Thus the masonry units shall have interlocking and inter-fitting projections and depressions that will interlock and inter-fit without any gap.

The form work is made with unequal length of masonry units at two ends, so that the vertical joints along the height of formwork shall be staggered. In case of columns of large length or shear walls, interiors masonry units between channel shaped end units shall be inserted between them. The interior masonry units shall be plane rectangular masonry unit of height and thickness same as that of channel masonry unit-7 having similar interlocking and interfitting projection on one of the horizontal and a vertical edges and interlocking and inter-fitting depression on the other horizontal and vertical edges. It can be made with machine by modifying mould-7 slightly or manually of height and thickness same as that of channel shaped masonry unit.

Other important feature of moulds-1 to 4 is that the height of the said projection is less than the depth of the depression in the horizontal and end plates without an opening. In case of solid masonry unit, a horizontal gap is formed around each masonry units in the masonry system when masonry units are interlocked and inter-fitted with the adjoining masonry units. In case of hollow masonry units, two masonry units are placed together with ends with an opening and ends without an opening and a gap is formed around each pair of two masonry units, which are interconnected and become continuous in the masonry system.

Other important feature of moulds-5 and 6 is to make masonry units for dry staked, mortar less masonry system by making height of projection and depth of depression same for interlocking and interfitting features of horizontal and end plates. Thus the masonry units in masonry system shall fit on all four surfaces without any gap being mirror images. Displacement of masonry units in the masonry system along the length of wall shall be prevented by the outward projection of middle half of top and bottom surfaces. The displacement normal to masonry units shall be prevented by interlocking and interfitting of horizontal and vertical surfaces of masonry units. The vertical displacement shall be prevented by interlocking and interfitting of vertical surfaces of the masonry units. Thus the bonding of masonry units with mortar is not required.

Other important feature of mould-7 for making formwork for column and shear wall is that the interlocking and interfitting projections and depressions within its thickness on all exposed edges are mirror images enabling interlocking and inter-fitting of masonry units without any gap. The formwork for column is made by interlocking and inter-fitting of two masonry units side by side and above the lower masonry units. The vertical joints along the height of formwork are staggered by using two units of different length. The thickness of wall of masonry units shall be limited to about 5 mm less than the clear cover to stirrups. In case of columns of large length or shear walls, interlocking and interfitting interior masonry units along the length and height of the formwork shall make the formwork.

Brick receiving unit: According to another embodiment of the invention, brick receiving unit (11) is next to brick making unit to receive masonry units after it is made and ejected from the moulds. It is taken out of the platform either manually or mechanically such as with the use of convey or belt (12).

Hydraulic System: According to another embodiment of the invention, hydraulic system (13) comprises of four hydraulic jacks for movement of shaft and end plates. Jack (14) is used for movement of shaft to make hollow in masonry unit. Jacks (15, 16) are used for movement of the end plates from both ends to close the mould and make masonry units.

According to another embodiment of the invention, the machine has a hopper (1), which receives the material from the mixer (2) through the conveyor belt. Vibrator is fixed to the hopper for creating easy flow of the material to the moulds of the masonry unit.

Operation of Machine: It is operated by closing the left and right ends of the moulds by moving both the end plates with the help of jacks. In case of moulds for making hollow bricks, the shafts are inserted through the opening of the hollow end plates up to about 50 mm. Then the required quantity of material is dropped in the moulds through hopper and vibrated to spread the material uniformly. Then the shafts are pushed inside the moulds up to the desired position. Thereafter, the end plates on the other side of brick ejection unit are pushed inside the mould to create desired pressure and length of masonry unit. Then, the end plates without an opening are taken out and pushing the end plates with an opening ejects the masonry units. Then the masonry units are taken out either manually or with the help of conveyer belt.

According to another embodiment of the present invention, masonry construction with masonry units −1 to 4 is done by placing masonry units one after another and one above the other without any mortar between them, interconnected and self-aligned due to interlocking and inter-fitting between them and forming a gap around each solid masonry unit or around two hollow masonry units in the masonry system where two hollow masonry units are placed together with ends with an opening and ends without an opening. The ends with an opening have either projection or depressions which are mirror images that enable the interlocking or inter-fitting of masonry units without any gap. Then the bonding of masonry units is achieved by pumping cement and water mixture (slurry) from one or more locations. To achieve a better bonding, non-shrinkable material to avoid shrinkage of mortar and cement based polymer or epoxy can be added to the slurry.

According to another embodiment of the present invention, masonry construction with masonry units −5 to 6 is similar to that with masonry units −1 to 4 except that no bonding of masonry units are required as the interlocking and interfitting projections and depressions are mirror images, thus enabling fitting of masonry units without any gap.

Another embodiment of the present invention relates to masonry system at L, T and + joints, which shall be produced by making minor modifications to moulds.

Another embodiment of the present invention relates to reinforced brick or block masonry, which shall be produced by making minor modifications to moulds.

According to another embodiment of the present invention, economy in masonry construction is achieved due to reduced thickness of slurry for bonding masonry units resulting in increased strength of masonry as high as 70 to 80 percent of the strength of masonry unit where as the strength of conventional masonry is only 30 to 40 percent of the strength of masonry unit. Dry staked masonry construction eliminates mortar completely.

### ADVANTAGES OF INVENTION

Following are the advantages of the present invention:
1. The present invention facilitates semi-automated masonry construction.
2. Masonry construction is of a much better quality compared to conventional masonry work due to self-alignment and self-adjustment of masonry units which results from its interlocking and interfitting feature which in turn results in uniform bonding of masonry units achieved by pumping slurry from the top or from the sides as appropriate.
3. Curing of wall is not required as the slurry for bonding the masonry units is confined within the thickness of wall.
4. Cement consumption for masonry work with masonry units-1 to 4 is about 15 percent of the cement required for conventional masonry work grouting is required.
5. Dry staked, mortar less masonry with masonry units-5 and 6 does not require any grouting thus eliminating any requirement of cement and making the construction faster and more economical.
6. Plaster is not required for masonry wall with proposed invention.
7. Reduced time of construction and reduced manpower requirements as even an unskilled worker can do the construction.
8. Hollow bricks result in increased thermal insulation, reduced dead and earthquake loads and hence result in an economical structural design.
9. Strength of brick wall made as per the proposed technology is about two times more than that by the existing technology because the thickness of slurry for bonding the masonry units is only 5 mm and is confined within the brickwork.
10. Building units can have various predetermined dimensions depending upon the type of construction, by making minor modifications to moulds-1 to 7.
11. Building units can be manufactured faster and economical than the conventional masonry units.
12. Abundantly available fly ash shall be used as one of the main constituent of the materials for making masonry units.
13. The inward depression of lower masonry and outward projection of upper masonry within their width and along their length at a horizontal joint provide enhanced interlocking and interfitting of masonry units resulting in its improved behavior under gravity and earthquake loads.
14. The inward depression on the vertical surface of a masonry unit and outward projection on the vertical surface of adjoining masonry unit within their width and along their depth at a vertical joint provide enhanced interlocking and inter-fitting of masonry units resulting in an improved behavior under gravity and earthquake loads.
15. The outward projections of middle half on both horizontal surfaces of masonry units provide enhanced interlocking and interfitting of masonry units resulting in an improved behavior under gravity and earthquake loads.
16. Reinforced masonry system and the formwork for columns and shear walls can be made more economically.

### BRIEF DESCRIPTION OF DRAWINGS

The present invention is described with reference to the accompanying figures.

FIG. 1 shows geometry of some of the existing interlocking masonry units. FIG. 1(a) shows the Haener block, FIG. 1(b) shows the Mecano system, FIG. 1(c) shows the Sparlock system having half course stretcher and half course end unit, FIG. 1(d) shows the WHD system, FIG. 1(e) shows the Tasta System and FIG. 1(f) shows the Link Block system.

FIGS. 2 and 3 show different components of brick making machine, hopper and conveyor belt. Machine has a hopper (1) over moulds (100) which receives the material from the mixer (2) through the conveyor. A vibrator (3) is fixed to the hopper for creating easy flow of the material to the moulds of the shape and configuration of the masonry unit. Moulds are mounted on the brick making unit (10) for making masonry units. Seven types of moulds have been developed to make seven types of masonry units. Brick receiving plate form (11) is next to brick making unit to receive masonry units after it is made and ejected from the mould consisting of a plate of length bigger than the length of the masonry unit. Plate can be taken out of machine manually or mechanically such as with the use of conveyor belt (12). The mechanism is performed with the help of hydraulic system (13) comprising jacks (15, 16) for movement of end plates from left and right side and jack (14) for movement of shafts along the length of moulds to make hollow in the brick.

FIGS. 4A and 4B show a typical mould-1 for making solid rectangular masonry unit-1 as shown in FIG. 11. Bottom horizontal plate (101) of mould has a depression within its width and along its length and the top horizontal plate (102) has matching projection within its width and along its length in conformity with the said depression. The vertical plates (201, 202) are plane. One of the end plate (301) has a depression and the other end plate (302) has a matching projection within their width and along their height. The end plates are connected with jacks (15, 16) for movement inside and outside the moulds.

FIG. 5 shows a typical mould-2 for making hollow rectangular masonry unit-2 as shown in FIG. 12. A shaft (20) passes through end plate with opening along the length of mould to make hollow in the masonry unit. It is similar to mould-1 (FIG. 4) except that the end plate without an opening of a mould shall have interlocking and interfitting projection and depression within four walls of other end plate with an opening. The other mould with end plate without opening shall have interlocking and interfitting depression and the end plate with opening shall have interlocking and interfitting projection within their four walls. The interlocking and interfitting depression and projection in end plates with an opening are mirror images enabling their interlocking and interfitting without any gap.

FIGS. 6A and 6B show a mould-3 for making solid masonry unit-3 as shown in FIG. 13. It is similar to mould-1 (FIG. 4) except that the middle half of the horizontal plates (101, 102) are projected outward by 05 mm to 20 mm depending on the size of the masonry unit. The upward projection of middle half of horizontal plates are obtained by fixing identical horizontal plates (103, 104) at bottom and at top of end plates (301, 302) and has thickness equal to the outward projection of the horizontal plates. It has identical interlocking and interfitting projections or depressions as that of horizontal plates and are inserted within the mould at a length equal to one fourth of the length of masonry unit.

FIG. 7 shows a mould-4 for making hollow masonry unit-4 as shown in FIG. 14. It is similar to mould-2 (FIG. 5) except that the middle half of the horizontal plates is projected outward similar to mould-3 (FIG. 6).

FIG. 8 shows mould-5 for making solid masonry unit-5 for dry staked mortar less masonry work, which is similar to mould-3 except that the interlocking and interfitting projections and depressions in horizontal and end plates are equal so that the masonry units interlock and interfit without any gap being mirror images. The end plate without an opening shall have a similar feature within their width and height enabling interlocking and interfitting without any gap being mirror images.

FIG. 9 shows mould-6 for making hollow masonry unit-6 for dry staked mortar less masonry work, which is similar to mould-4 except that the interlocking and interfitting projections and depressions are equal so that the masonry units interlock and interfit without any gap being mirror images. The end plate without an opening shall have similar feature within their width and height, thus enabling interlocking and interfitting without any gap being mirror images.

FIGS. 10A and 10B show mould-7 for making channel shaped masonry unit for shuttering of column and shear wall as shown in FIG. 15. It consists of a plane horizontal plate at bottom (101) and plane vertical plates (201, 202). The top horizontal plate (102) has interlocking and interfitting projection at one longitudinal edge and depression at other longitudinal edge within the width equal to the thickness of masonry unit. Both the end plates are hollow from top (FIG. 10) whose vertical and horizontal members are of width equal to the thickness of wall of masonry unit. A shaft passes through the opening of one of the end plates up to the other end plate touching the top horizontal plate. One of the end plates (301) has interlocking and interfitting projection and the other end plate (302) has matching depression within the horizontal and vertical member as shown in the figure. The interlocking and interfitting projection and depression of moulds are mirror image, enabling them to fit without any gap. Mould for making interior masonry units, which are plane rectangular of height and thickness same as that of channel masonry unit having similar interlocking and interfitting features within their thickness on four edges as shown in FIG. 15, can be made easily for production with machine or manually by slightly modifying the mould.

FIG. 11 shows various embodiments of solid rectangular masonry unit.

FIG. 12 shows various embodiments of hollow rectangular masonry unit.

FIG. 13 shows various embodiments of solid rectangular masonry unit with the middle half projected outwards.

FIG. 14 shows various embodiments of various embodiments of hollow rectangular masonry unit with middle half projected outwards.

FIG. 15 shows various embodiments of channel shaped masonry unit.

FIG. 16 shows various embodiments of interlocking and interfitting of solid rectangular masonry unit shown in FIG. 11.

FIG. 17 shows various embodiments of interlocking and interfitting of hollow rectangular masonry unit shown in FIG. 12.

FIG. 18 shows various embodiments of interlocking and interfitting of solid rectangular masonry unit with middle half projected outward shown in FIG. 13.

FIG. 19 shows various embodiments of interlocking and interfitting of hollow rectangular masonry unit with middle half projected outward shown in FIG. 14.

FIG. 20 shows various embodiments of interlocking and inter-fitting of channel shaped masonry unit as shown in FIG. 15.

FIG. 21 shows masonry unit for use in L joints.

FIG. 22 shows masonry unit for use in T joints.

FIG. 23 shows masonry unit for use in +joints.

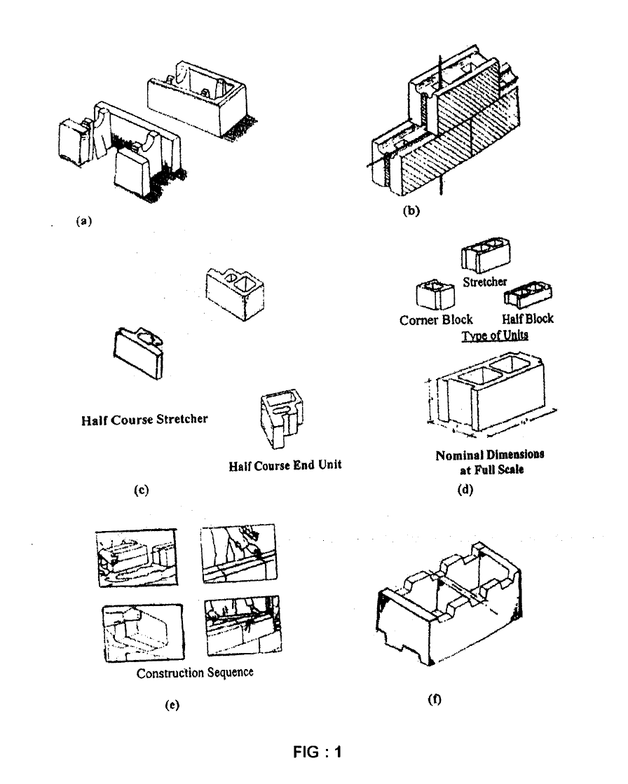

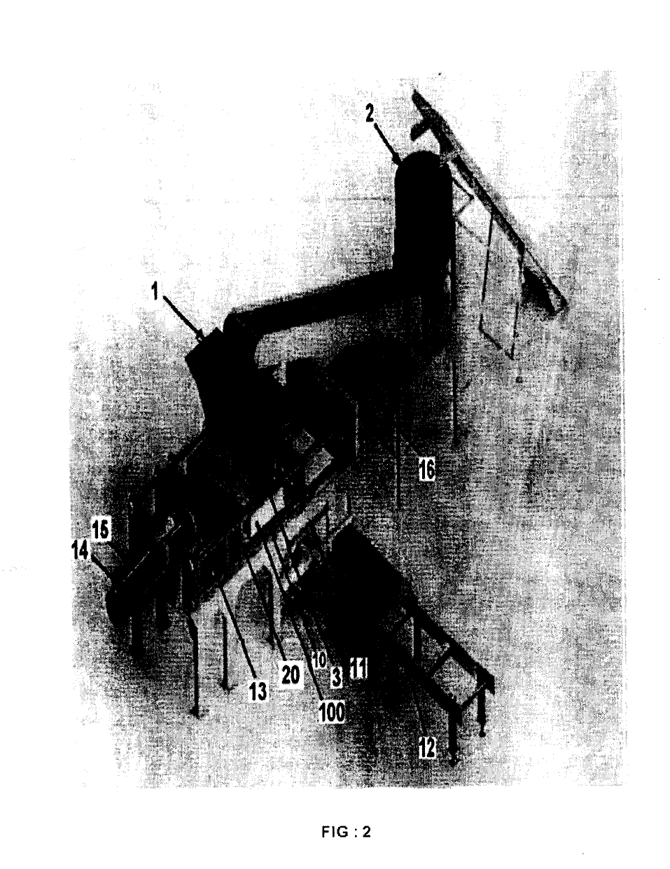

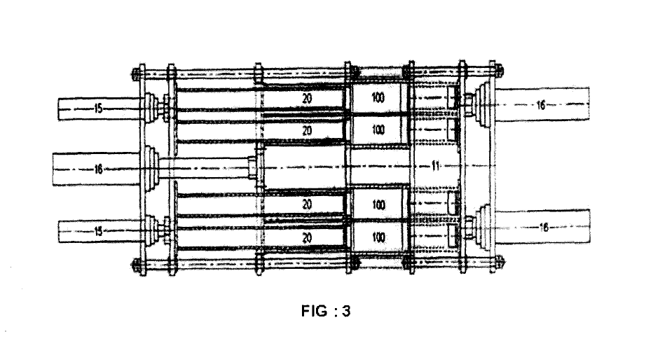

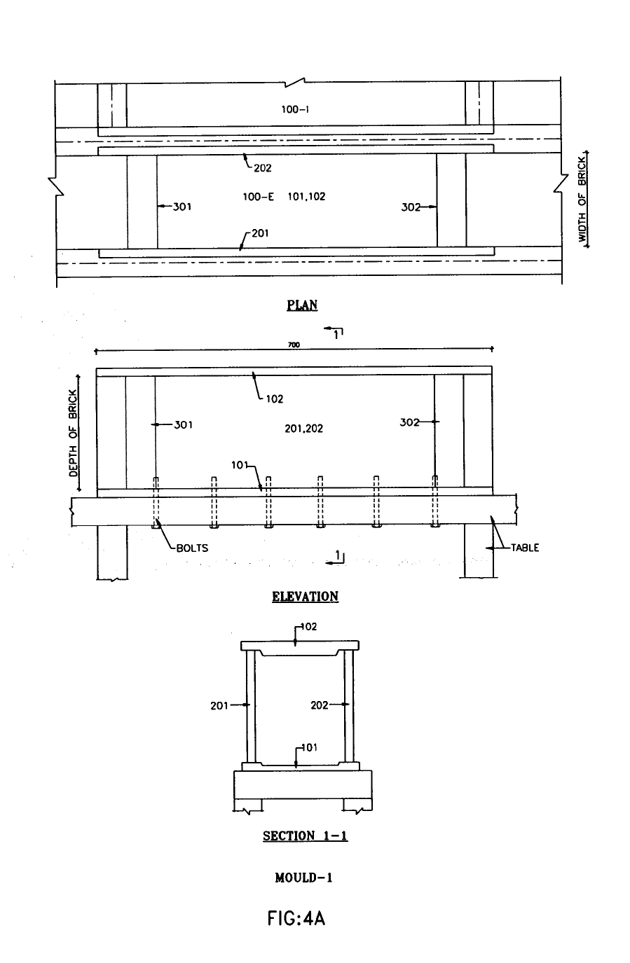

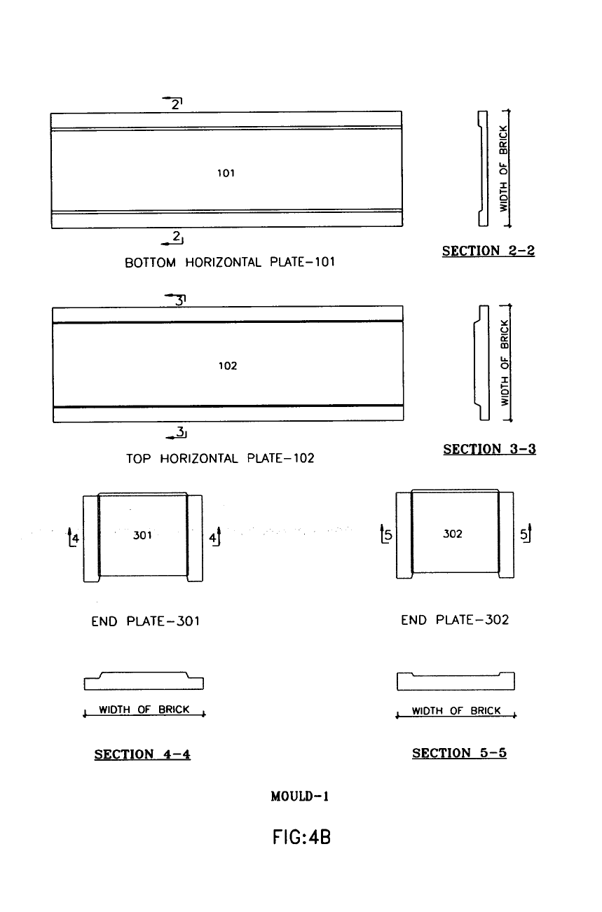

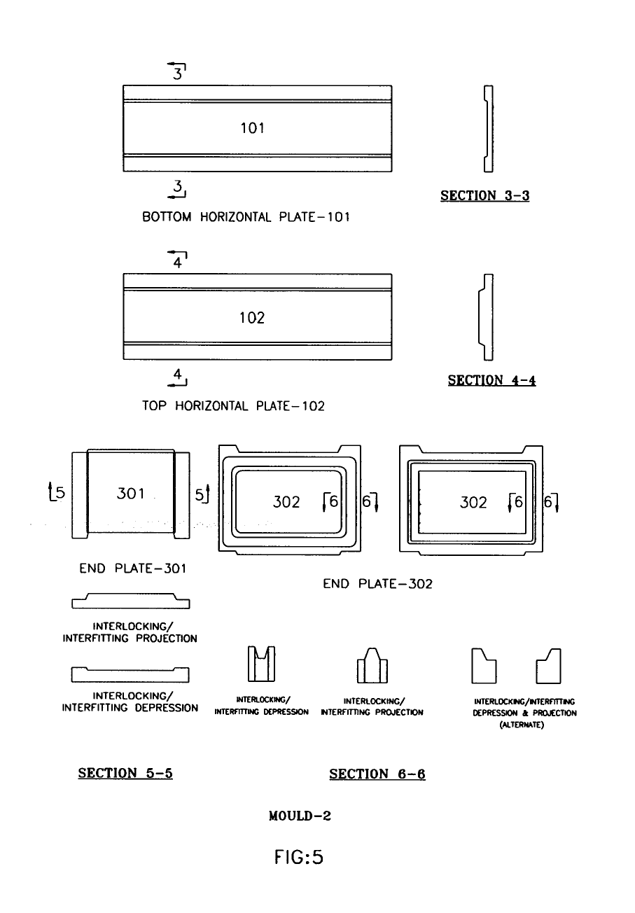

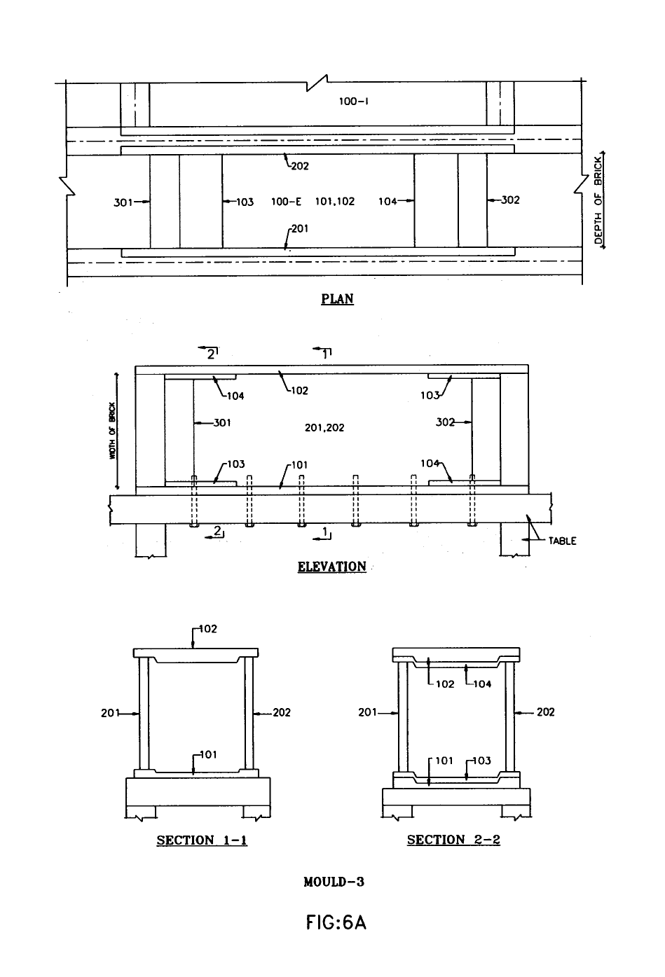

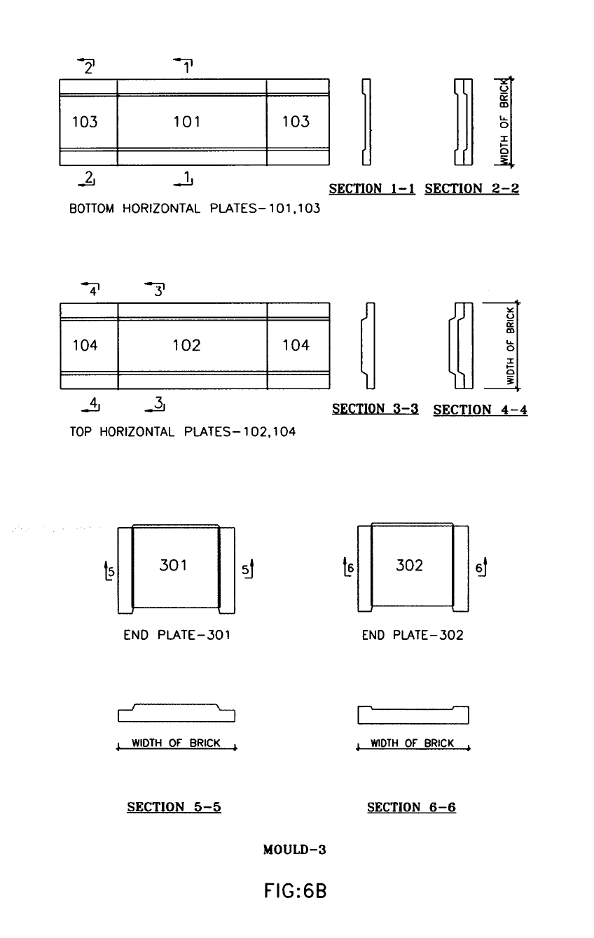

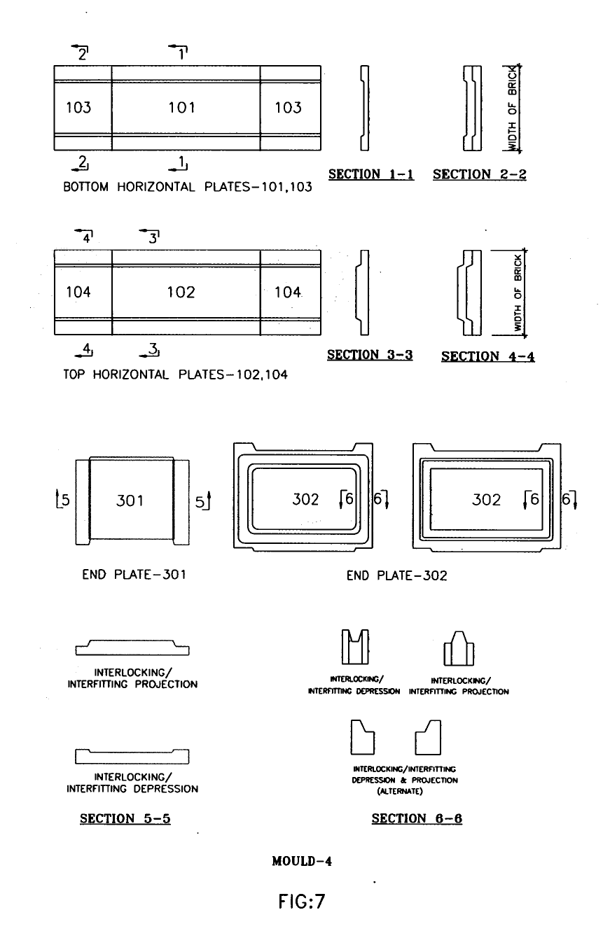

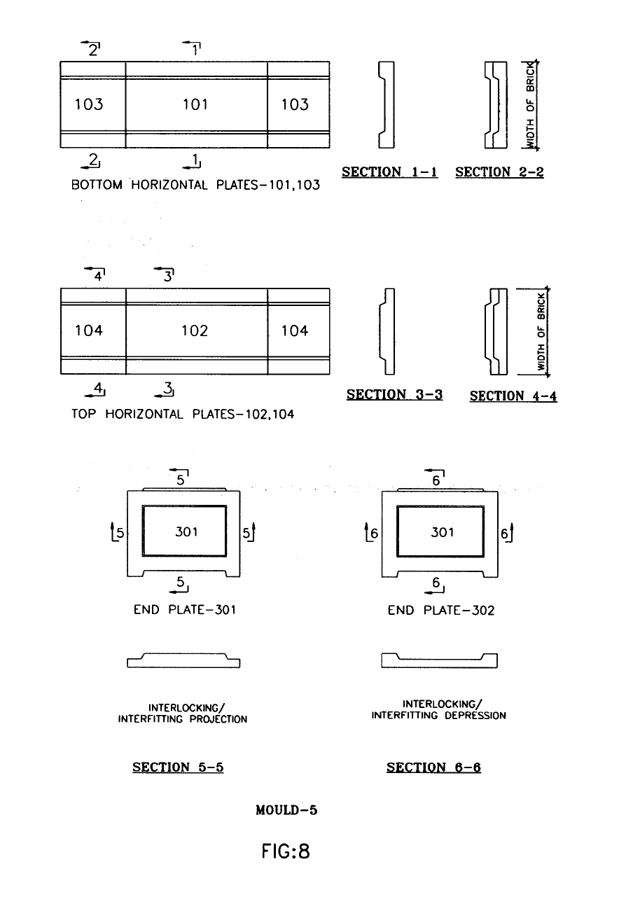

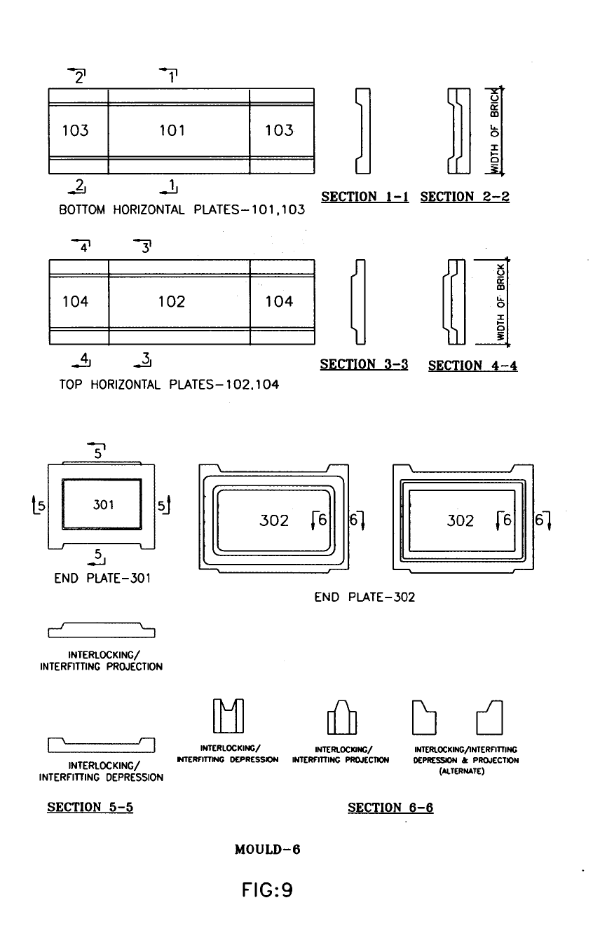

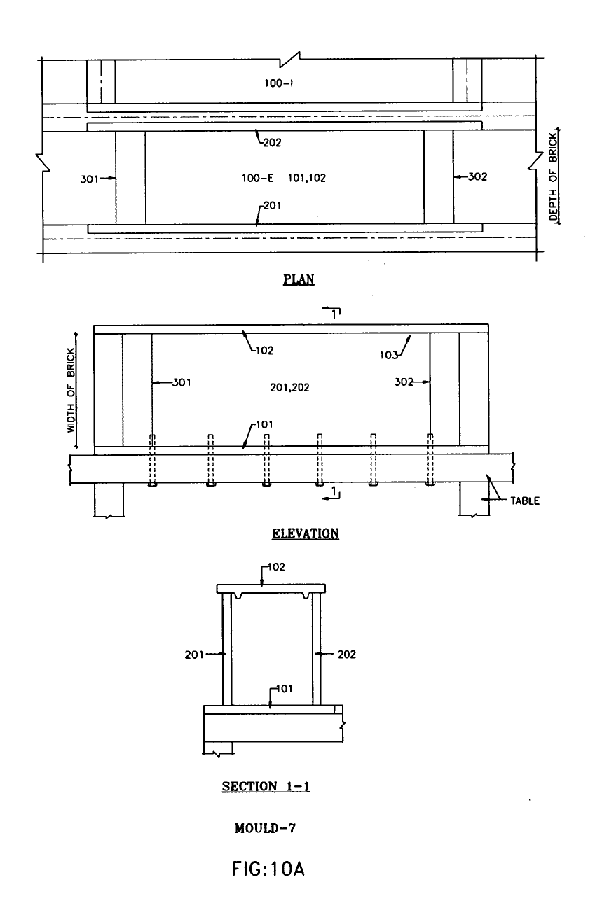

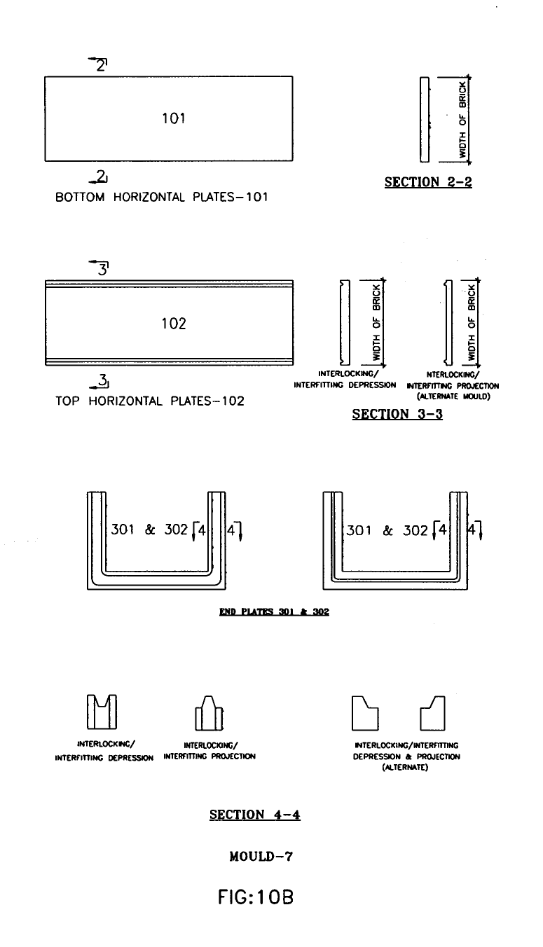

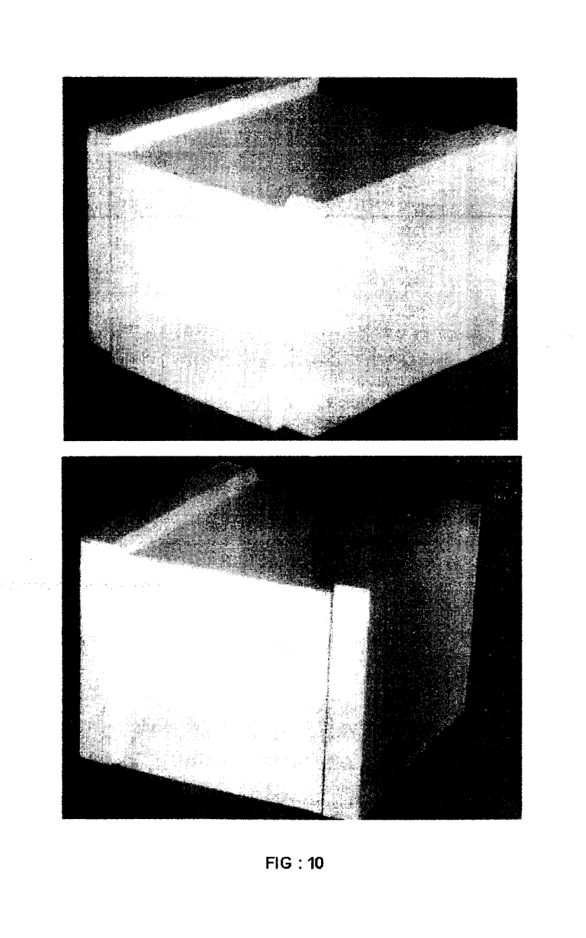

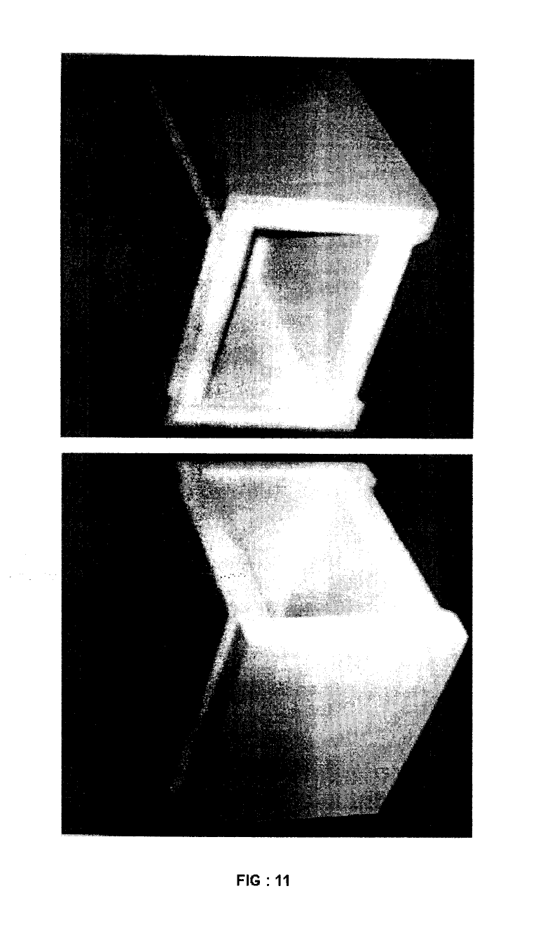

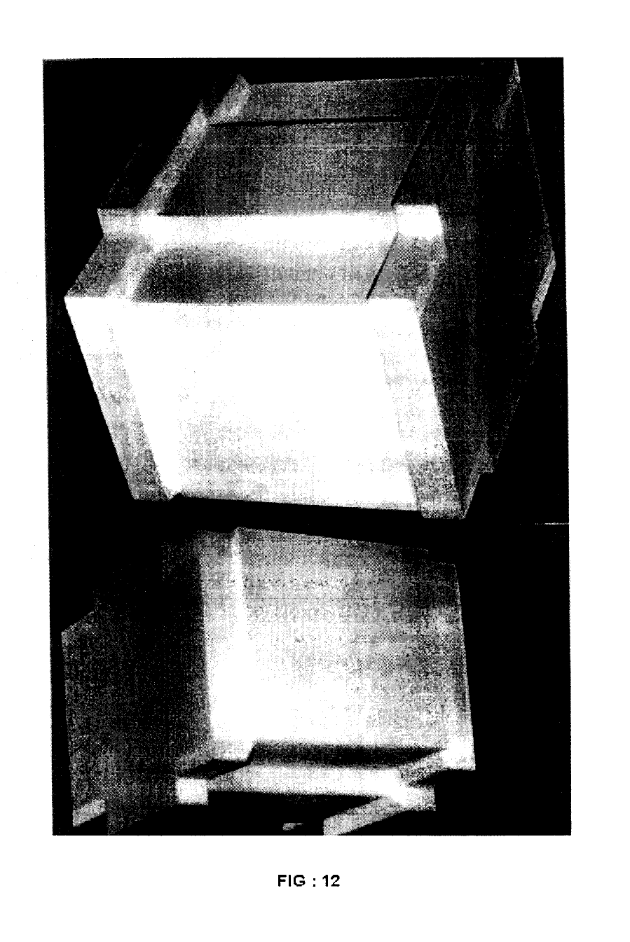

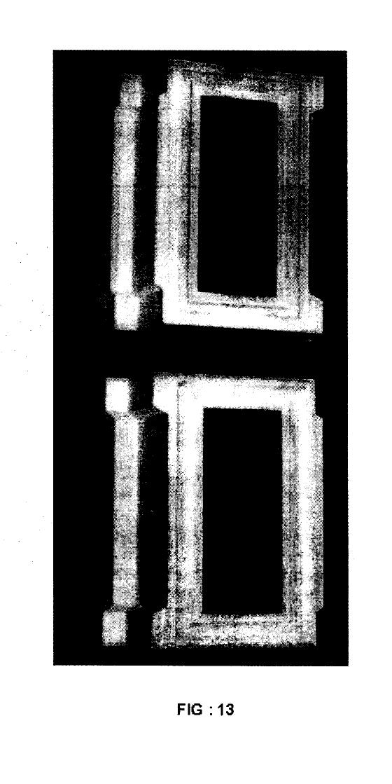

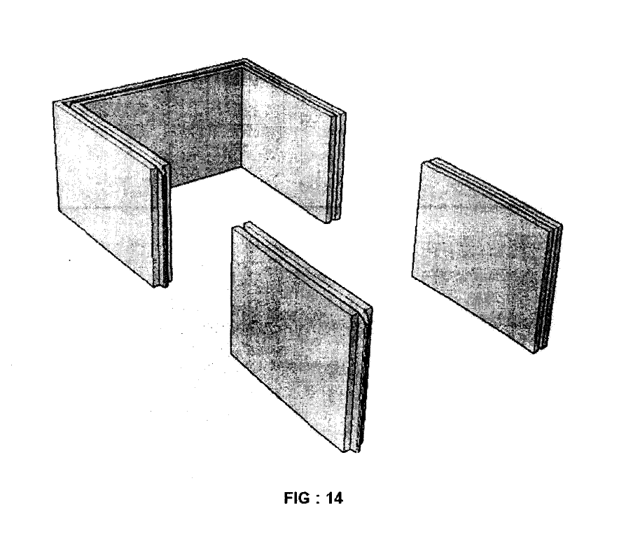

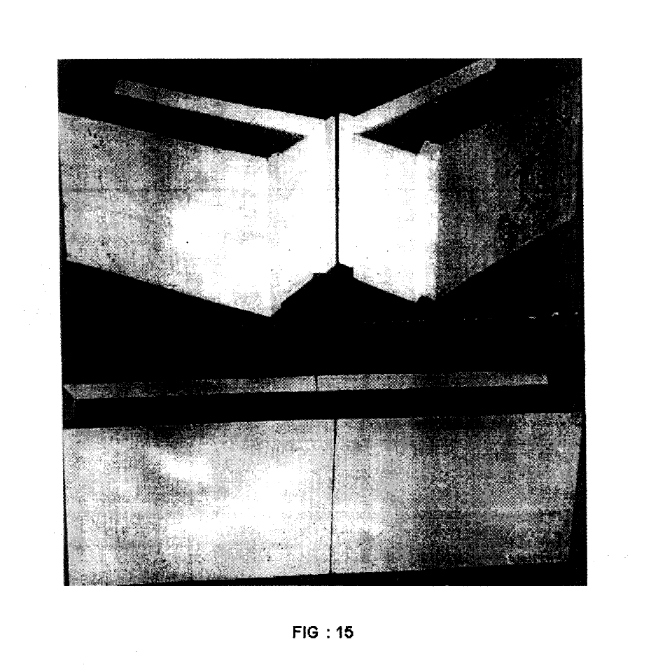

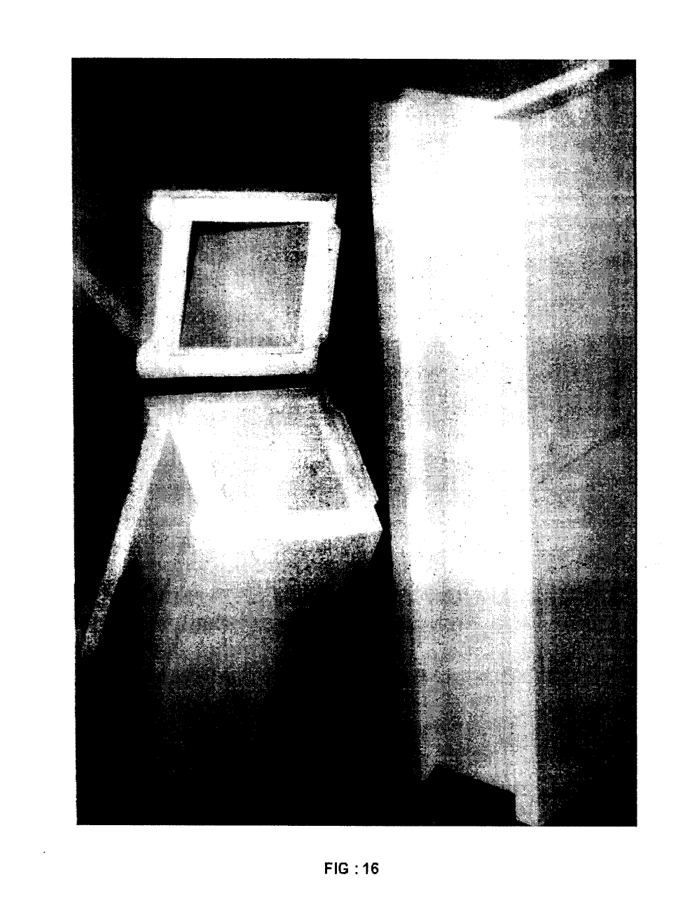

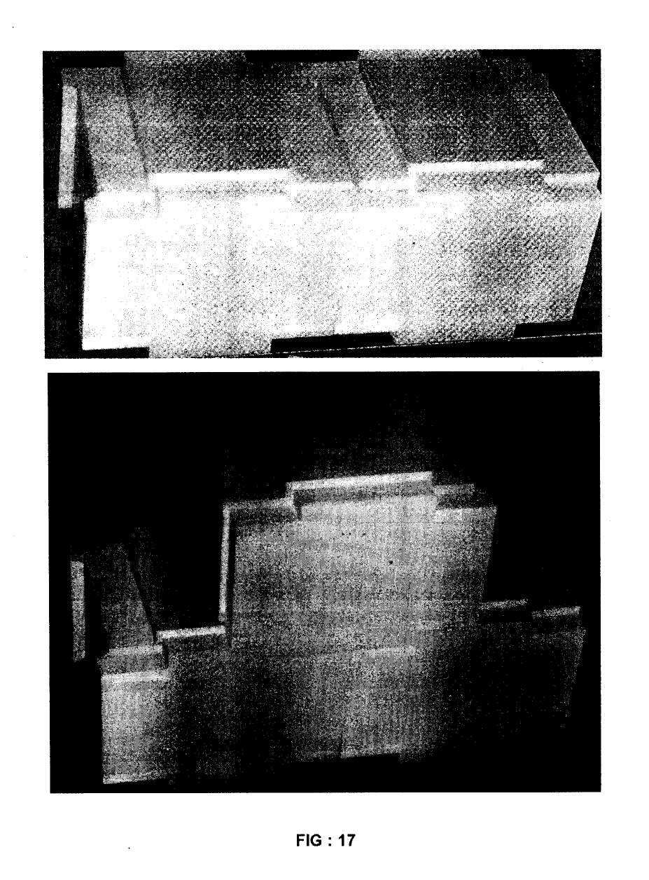

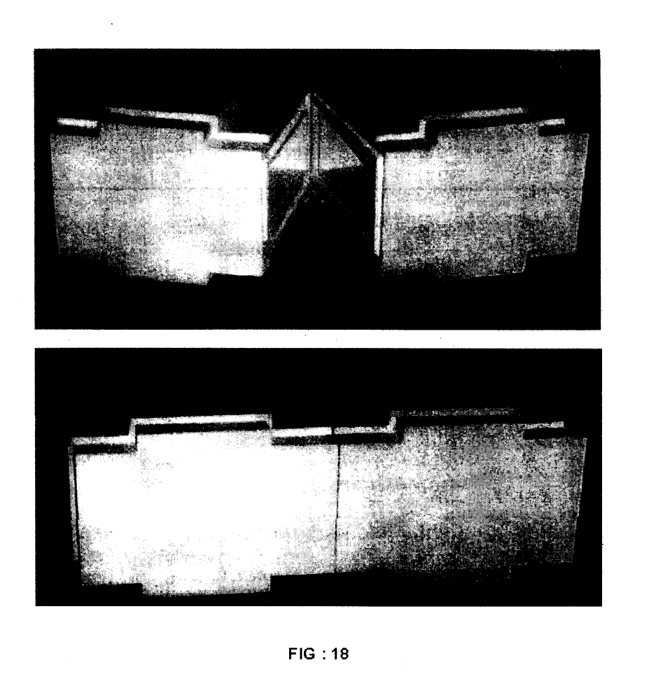

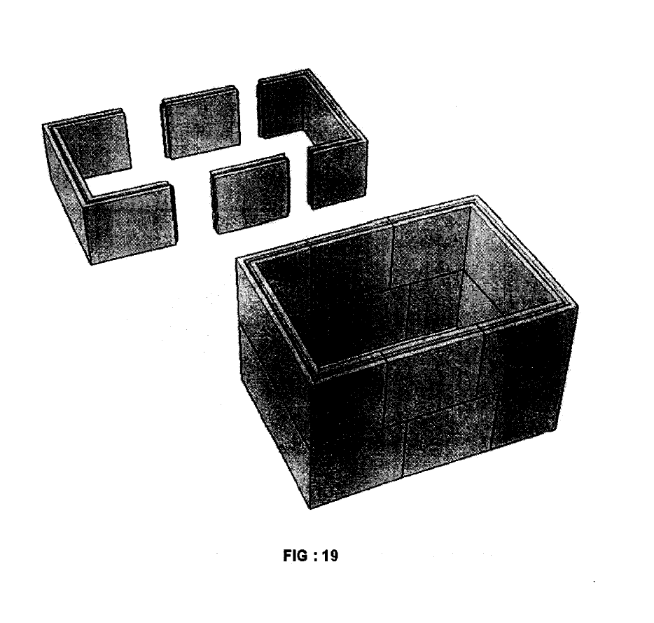

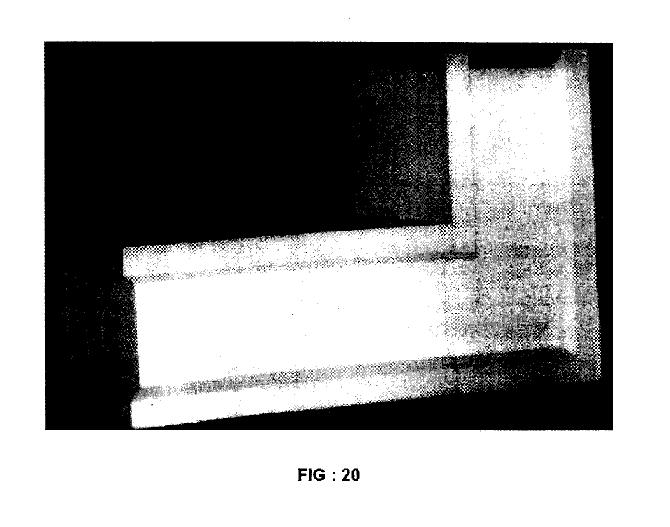

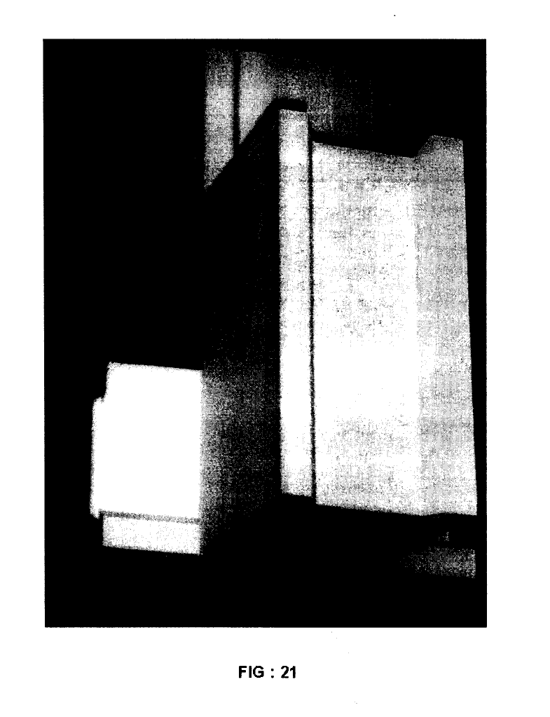

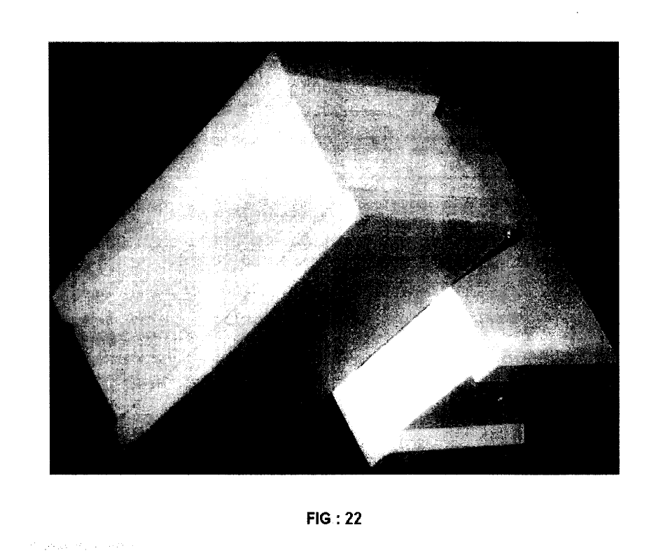

The above description of the exemplary embodiments according to the present invention serves only for illustration purposes and not to restrict the invention. Various changes and modifications are possible within the context of the invention, without departing from the scope of the invention and its equivalents.

List of reference numerals used in drawings are:
1: Hopper
2: Mixer
3: Pump
10: Brick making machine
11: Brick ejection unit
12: Conveyor belt
13: Hydraulic system
15: Jack for left end plate
16: Jack for right end plate
17: Jack for Shaft
20: Shaft
100: Moulds
100-I: Interior moulds
100-E: Exterior moulds
101: Horizontal plate-1
102: Horizontal plate-2
103: Horizontal plate-3
104: Horizontal plate-4
201: Vertical plate-1
202: Vertical plate-2
301: End plate-1
302: End plate-2

1. A machine for manufacturing interlocking and interfitting masonry having interlocking or interfitting projections and depressions which are self-alignable and self-adjustable for semi-automated masonry construction, comprising of a brick making unit (10), a brick ejection (11) and a hydraulic system (13) wherein:
moulds (100) provided in the brick making unit (10) having bottom, top and end plates with interlocking and interfitting features plane vertical plates,
an ejection unit provided adjacent to the brick making unit (10) to receive masonry units after election from the mould having plate longitudinally larger than the length of the masonry unit,
a plurality of hydraulic jacks (15,16) provided for movements of end plates of the moulds from both ends to make masonary units at a pressure of about 40 to 60 kg per sq.cm and another jack (17) provided to move shafts (20) along the length of mould to make hollow in the masonry units.

2. A machine for manufacturing the masonry in claim 1, wherein the machine has a horizontal rectangular frame of about 4.5 m length and the width of about 2.0 m depending on the number of masonary units to be made in one cycle of operation.

3. A machine for manufacturing the masonry units as claimed in claim 1, wherein the masonry units are made of a homogeneous mixture of about 5 to 20 percent of cement, 30 to 70 percent of fly ash, 20 to 60 percent of sand or a homogeneous mixture of 5 to 20 percent of cement, 30 to 70 percent of fly ash, 20 to 60 percent of clay or a homogeneous mixture of 5 to 20 percent of cement, 30 to 70 percent of sand, 20 to 60 percent of clay wherein the mixture may also consist of a suitable proportion of other bonding materials such as lime and gypsum, and sand may be river and or stone dust or marble, stone or granite dust in suitable proportion, all ingredients of materials for making masonry units are mixed with required quantity of water to make moist mix and the water may be mixed with required quantity of plasticizer of desired property or cement based polymer or epoxy, a suitable quantity of fibre may also be used.

4. A machine for manufacturing the masonry units as claimed in claim-1, wherein seven types of moulds are used to make seven types of masonry units having hollow rectangular box provided with bottom and top horizontal rectangular steel plates (101, 102, 103, 104) with interlocking and interfitting features, front and back plane vertical rectangular steel plates (201, 202) and two end steel plates (301, 302) with interlocking and interfitting features.

5. A machine for manufacturing the masonry unit-1 as claimed in claim 1, wherein the bottom horizontal plate (101) has depression within its width and along its length and top horizontal plate (102) has a matching projection within its width and along its length in, conformity with the said depression and one of the end plate (301) has a depression within its width and along its height and the other end plate (302) has a matching projection within its width and along its height in conformity with the said depression, the end plates are connected with jacks for movement inside and outside the mould, wherein the depth of the said depression in the bottom horizontal plate and one of the end plate is less than the height of projection in the to horizontal plate and other end plate of the, mould such that the masonry units have the same feature, the height of projection on the bottom horizontal surface and one of the end surface is less than the depth of depression on the top horizontal surface and the other end surface of masonry unit.

6. A machine for manufacturing hollow rectangular masonry unit-2 as claimed ire claim 1, is similar to mould-1 as claimed in claim-5 for making solid rectangular masonry unit, except that one of the end plate has a rectangular opening for movement a shaft through it for making hollow with an opening from one end and closed on other end, wherein a mould with an end plate without an opening and having interlocking and interfitting projection shall have interlocking and interfitting depression within four walls of other end plate with an opening and the other mould with an end plate without an opening and having interlocking and interfitting depression having interlocking and interfitting projection within four walls of the other end plate with an opening, wherein the depth of the said depression in the bottom horizontal plate and one of the end plate is less than the height of projection in the top horizontal plate and the other end plate of the mould, such that the interlocking and interfitting depression and projection within four walls of the end plates with an opening are mirror images.

7. A machine for manufacturing the solid masonry unit-3 is similar to mould-1 as claimed in claim-5 for making solid rectangular masonry unit-1, except that the middle half of the bottom and top horizontal plates are projected outward by 5 mm to 20 mm or more depending on the site of the masonry unit where the upward projection of middle half of horizontal plates are achieved by fixing identical horizontal plates (103, 104) at bottom and top of end plates (301, 302) and has thickness equal to the outward projection of the horizontal plates and has identical interlocking and interfitting projection or depression as that of horizontal plates and are inserted within the mould length equal to one fourth of the length of masonry unit, wherein the depth of the said depression in the bottom horizontal plate and one of the end plate is less than the height of projection in the top horizontal plate and other end plate of the mould.

8. A machine for manufacturing the masonry unit-4 is similar to mould-2 as claimed in claim-6 for making hollow rectangular masonry unit-2, except that the middle half of the bottom and top horizontal plates are projected outward by 5 mm to 20 mm or more depending on the size of the masonry unit as claimed in claim 6, wherein the depth of the said depression in the bottom horizontal plate and end plate without an opening of a mould is less than the height of projection in the top horizontal plate and end plate without opening of other mould such that the masonry units have the same feature, the height of projection n the bottom horizontal surface and end surface without an opening of a masonry unit is less than the depth of depression on the top horizontal surface and end surface without an opening of other masonry unit enabling two masonry units when interlocked and interfitted having a gap within their width all around the two masonary units.

9. A machine for manufacturing the masonry unit-5 as claimed in claim-1 is similar to mould-3 as claimed in claim-7 for making solid masonry unit-3, except that the locking and interfitting features of and plates are within their height forming a rectangle and the interlocking and interfitting features on horizontal and end plates are mirror image such that the masonry units have the same feature, the interlocking and interfitting projections and depression are mirror images enabling interlocking and interfitting of masonry units without any gap.

10. A machine for manufacturing the masonry unit-6 as claimed in claim 1 is similar to mould-4 as claimed in claim-8 for making hollow masonry unit-4, except that the that the interlocking and interfitting features of end plates without opening are within their height forming a rectangle and the interlocking and interfitting to features on horizontal and end plates are mirror image such that the masonry units have the same feature, the interlocking and interfitting projections and depression being mirror images enables interlocking and interfitting of masonry units without any gap.

11. A machine for manufacturing channel shaped masonry unit-7 as claimed in claim-1 for formwork of columns and shear walls consist, of a plane horizontal plate at bottom and plane vertical plates, wherein the top horizontal plate has interlocking and interfitting projection at one longitudinal edge and depression at other longitudinal edge within the width equal to the thickness of masonry unit, and both the end plates are hollow from top whose vertical and horizontal members are of width equal to the thickness of wall of masonry enabling a shaft to pass through the opening of one of the end plates up to the other end plate touching the, top horizontal plate, one of the end plates has interlocking and interfitting projection and the other end plate has depression within the horizontal and vertical members, wherein the mould king interior masonry units, which are plane rectangular of height and thickness same as that of channel masonry unit having similar interlocking and interfitting features within their thickness on four edges made easily for production with machine or manually by slightly modifying the mould.

12. A machine for manufacturing the masonry units as claimed in any of the preceding claims, having inclined surfaces of projections and depressions at any angle from 45 to 7 degree with the horizontal surface.

13. A machine for manufacturing the masonry as claimed in the preceding claims, wherein the width of projections and depressions on horizontal and end surfaces without opening is 0.6 to 0.9 times the width of masonry unit and depth of projections and depressions is 4 mm to 15 mm and 8 mm to 24 mm respectively so that a gap of 4 mm to 20 mm is created all around the solid surfaces of masonry unit within the width of projection and depression for grouting.

14. A machine for manufacturing the masonry units as claimed in the preceding claims wherein a thin support may be provided in the centre of opening of masonry units with opening to enhance its stability and strength.

15. A machine for manufacturing the masonry units as claimed in claim-1, wherein the ejection of masonry units from the mould is performed by removing the left plate of mould and then pushing the right end plate while the shaft (20) is retained at it position in case of masonry units with opening.

16. A machine for manufacturing the masonry units as claimed in claim-1, wherein the L, T and + joints of masonry system is achieved by modifying the moulds to produce the modified masonry units.

17. A machine for manufacturing the masonry units aimed in the preceding claims, further the masonry construction with'masonry units-1 to 4 is done by placing masonry units one after another and one above other without any mortar between them, inter connected and self aligned due to interlocking and interfitting between them forming gaps all around the solid masonry unit where two solid masonry units are interlocked or interfitted or around two hollow masonry units where two hollow masonry units are placed ether with ends with an opening and ends without an opening such that the ends with opening has either projection or depression which are mirror images that enable the interlocking or interfitting of masonry units without any gap. Such gaps become continuous in the masonry system enabling pumping cement and water mixture (slurry) from one or more locations to bond all masonry units, further adding non-shrinkable material to the slurry to avoid shrinkage of slurry and further adding cement based polymer or epoxy to the slurry to achieve better bond.

18. A masonry construction as claimed in claim-17, wherein the masonry unit-5 for solid masonry construction or masonry unit-6 for masonry construction is dry staked as the interlocking and interfitting features of masonry units restrain its displacements in all three directions, thus eliminating the need of bonding of masonry units with mortar as in conventional masonry system or slurry as in above mentioned masonry system outlined in claim-17.

19. A masonry construction as claimed in claim-17, wherein the masonry construction for formwork of columns and shear walls with channel shaped masonry unit-7 is done by interlocking and interfitting of two masonry units side by side and above the lower masonry units where the vertical joints along the height of formwork are staggered by using two masonry units of different length and the thickness of wall of masonry units shall be limited to about 5 mm less than the clear cover to stirrups, in case of columns of large length or shear walls, interlocking and interfitting of interior masonry units along the length and height of formwork shall make the formwork.

20. A masonry construction as claimed in claim-17 and 18, wherein the reinforced masonry is achieved by modifying mould such that two symmetric holes in the masonry units at its mid width and at equidistance from its center and the holes aligned with the holes in upper and lower masonry units in the masonry system by creating the diameter of holes larger than the diameter of reinforcement bars inserted in it and then grouted with the cement and water mixture (slurry) added, with non-shrink chemical, moderately or heavily reinforced masonry walls are made by creating large opening in masonry depending on the number and diameter of reinforcement bars so that reinforcement bars with stirrups can be inserted in the opening and then grouted.
